(19) United States
(12) Patent Application Publication
(10) Pub. No.: US 2014/0071398 A1
(43) Pub. Date: Mar. 13, 2014

(54) Vision Training Apparatus

(71) Applicant: Joe T. GLASSCO, Westerville, OH (US)

(72) Inventor: Joe T. GLASSCO, Westerville, OH (US)

(21) Appl. No.: 14/018,956

(22) Filed: Sep. 5, 2013

Related U.S. Application Data
(60) Provisional application No. 61/699,998, filed on Sep. 12, 2012.

(51) Int. Cl. G02C 3/00; A63B 69/00

(52) U.S. Cl. CPC G02C 3/006; A63B 69/00
USPC 351/157

(57) ABSTRACT

A vision training tool that is used to enhance the vision of a user has a vision inhibitor and a strap. The vision inhibitor partially obstructs the user's field of vision and has a first blinder and a second blinder. The first blinder and the second blinder of the vision inhibitor cover the area around the user's eyes and block the user's peripheral vision. A first eyelet and a second eyelet that traverse through the first blinder and the second blinder respectively, provide small windows through which the user has a limited field of vision. The strap is connected to a first fastening region and a second fastening region positioned on opposite ends of the vision inhibitor. The strap secures the vision inhibitor to the user's head and allows the vision training tool to be worn while the user is in motion.

The current application claims a priority to the U.S. Provisional Patent application Ser. No. 61/699,998 filed on Sep. 12, 2012.

### FIELD OF THE INVENTION

The present invention relates generally to a pair of glasses. More specifically, the present invention provides a set of lens free glasses that are used to work out and train a user's vision.

### BACKGROUND OF THE INVENTION

Vision is very important, especially when it comes to sports. Athletes rely on good vision to be able to quickly react to different situations that occur on the playing field. They also rely on their vision for tasks requiring hand-eye coordination or foot-eye coordination. There are plenty of ways for athletes to train their bodies but there is no good way for them to train their vision. By training their vision athletes can enhance their muscle memory, thus enhancing their game time performance. Without training their eyesight, athletes are failing to develop a very integral part of their body.

Therefore it is the object of the present invention to provide a means of training an athlete's vision. The present invention is a pair of opaque glasses with a hole cut out for each eye. In this way the user can still see out of the glasses but much of their peripheral vision is removed. The glasses function as blinders that force the athlete to focus on one object. By focusing on one object athletes can better train their vision and muscle memory which will help them to better perform on the playing field.

### BRIEF DESCRIPTION OF THE DRAWINGS

FIG. 1 is a perspective view of the present invention.

FIG. 2 is a perspective view of the vision inhibitor.

FIG. 3 is a front elevational view of the vision inhibitor.

FIG. 4 is a left side elevational view of the vision inhibitor.

FIG. 5 is a rear elevational view of the vision inhibitor.

FIG. 6 is a right side elevational view of the vision inhibitor.

FIG. 7 top plan view of the vision inhibitor.

FIG. 8 is a bottom plan view of the vision inhibitor.

FIG. 9 is perspective view of the present invention, with the strap having a pair of adjustable fasteners.

FIG. 10 is a front elevational view of the vision inhibitor having lenses.

FIG. 11 is a front elevational view of the vision inhibitor having vision reduction inserts.

### DETAIL DESCRIPTIONS OF THE INVENTION

All illustrations of the drawings are for the purpose of describing selected versions of the present invention and are not intended to limit the scope of the present invention.

The present invention is a vision training tool that can be used for all types of athletes. The vision training tool comprises a vision inhibitor 1 and a strap 2. The vision inhibitor 1 partially obstructs a user's vision, while the strap 2 secures the vision inhibitor 1 to the user's head. While the strap 2 allows the vision inhibitor 1 to be worn while walking, running, jogging, etc., all objects and/or other people should be clear of the exercise area when the vision training tool is being used. The vision training tool is intended to be used during training sessions and not during actual game play. It is also intended to be used by those ages ten and older. While the vision training tool is used to train athletes in the preferred embodiment, it is possible that the vision training tool be used for applications other than athletics and be used by people of any age.

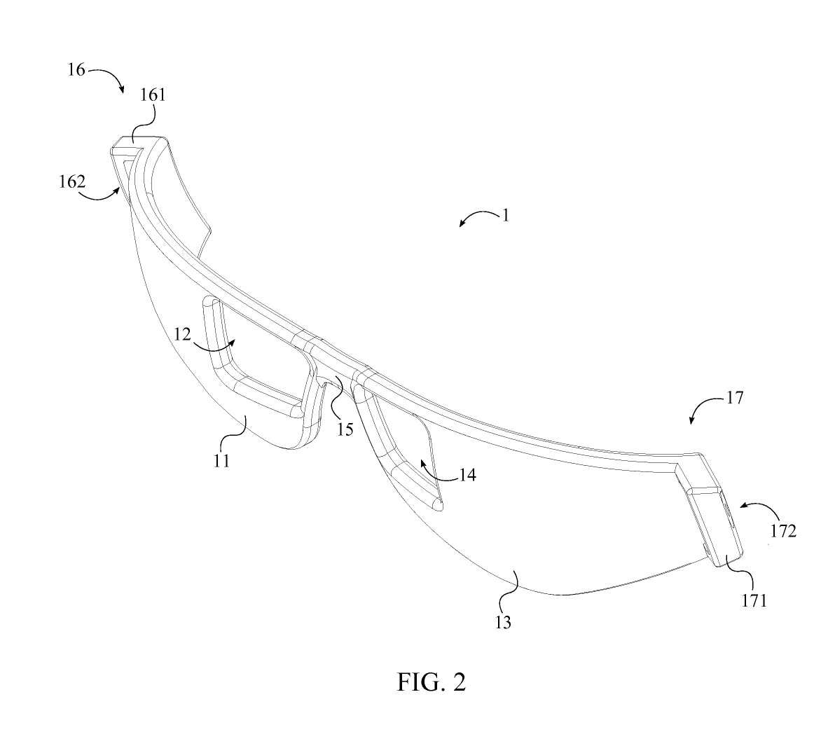

In reference to FIG. 2, the vision inhibitor 1 is positioned across the face of the user and comprises a first blinder 11, a first eyelet 12, a second blinder 13, a second eyelet 14, a bridge 15, a first fastening region 16, and a second fastening region 17. In the preferred embodiment of the present invention the vision inhibitor 1 is made of a rubberized material. However, it is possible that the vision inhibitor 1 be made of other materials including, but not limited to, plastic or composite materials. The vision inhibitor 1 is constructed of a single piece of opaque material and is curved to conform to the general shape of a person's face.

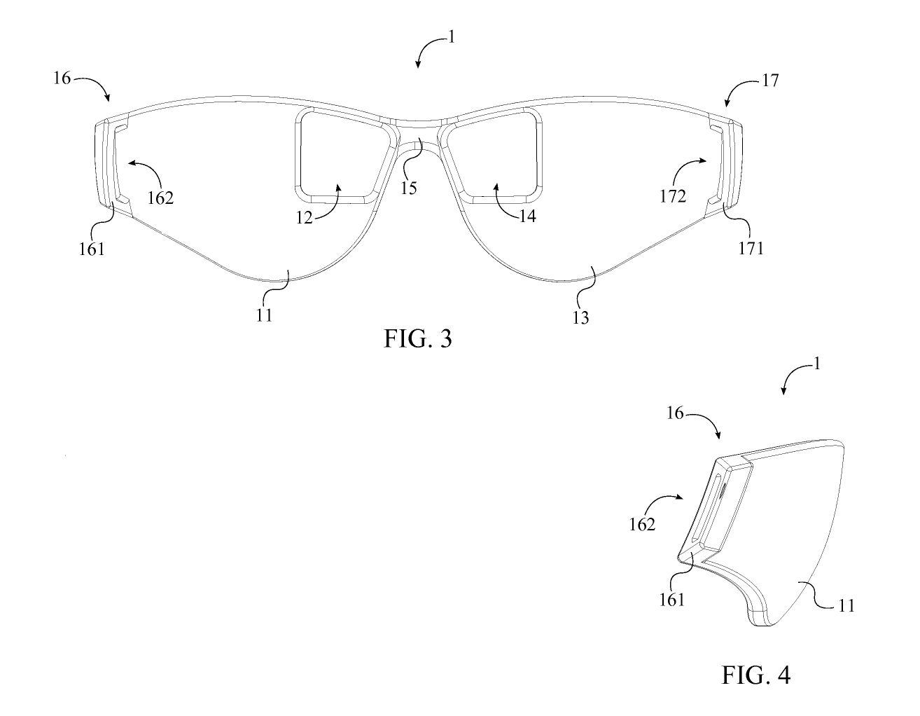

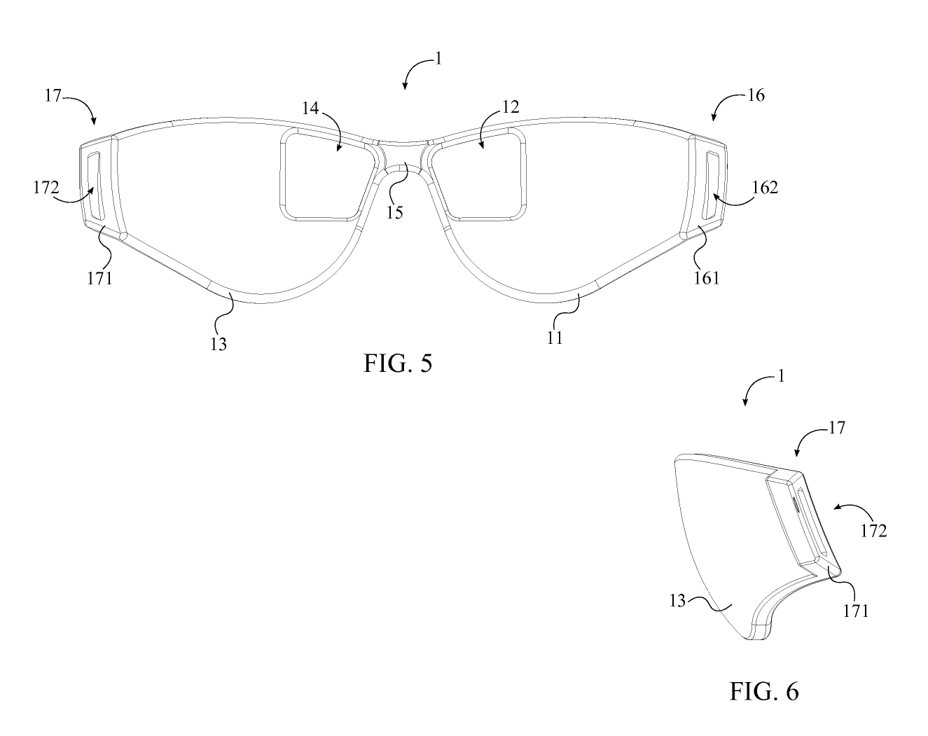

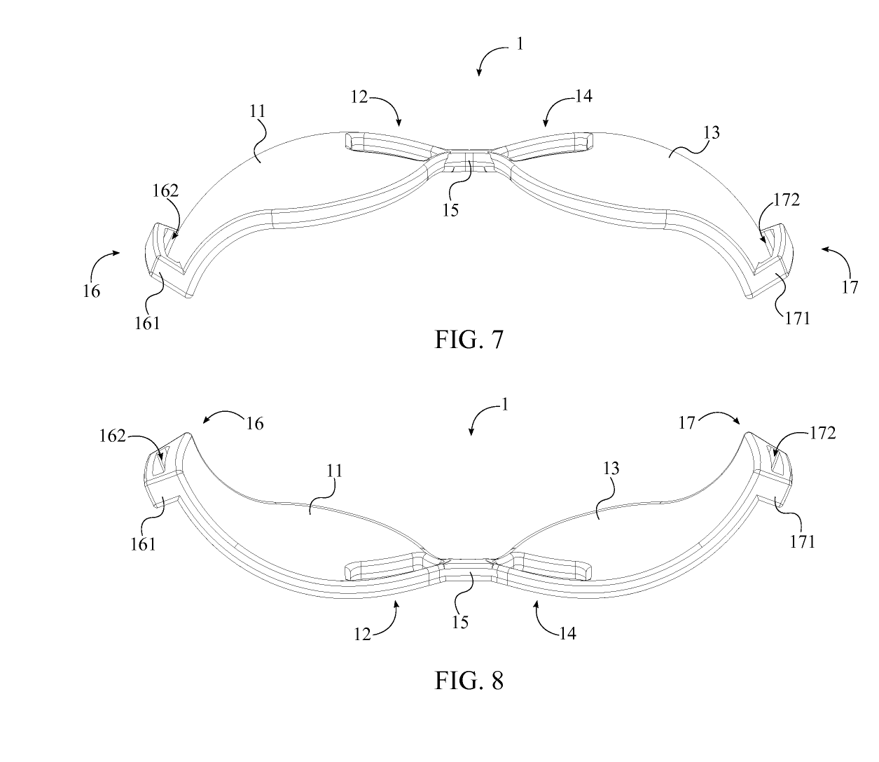

In reference to FIG. 3 and FIG. 5, the first blinder 11 and the second blinder 13 are the components of the vision inhibitor 1 that obstruct the user's peripheral vision. The bridge 15 supports the first blinder 11 and the second blinder 13 and rests across a user's nose when the vision inhibitor 1 is worn by a user. As such, the first blinder 11 is adjacently connected to the bridge 15, while the second blinder 13 is connected to the bridge 15 opposite the first blinder 11. Unlike a standard pair of glasses, there are no lenses as part of the vision training tool. However, the first eyelet 12 and the second eyelet 14 provide two cutouts in the vision inhibitor 1 through which the user can see. Each cutout is a minor image of the other, the first eyelet 12 traversing through the first blinder 11 and the second eyelet 14 traversing through the second blinder 13. Both the first eyelet 12 and the second eyelet 14 are positioned adjacent to the bridge 15, such that when the vision training tool is worn, the first eyelet 12 and the second eyelet 14 rest in front of the user's eyes, providing windows through which the user can see.

In the preferred embodiment of the present invention, the first eyelet 12 and the second eyelet 14 are trapezoidal in shape and feature rounded edges and are approximately three quarters of an inch to one inch wide. However, it is possible for the first eyelet 12 and the second eyelet 14 to be any other shaped and/or sized opening. The range of vision of the user is restricted when wearing the vision inhibitor 1 as compared to the range of vision available when wearing a normal pair of glasses due to the size and shape of the first eyelet 12 and the second eyelet 14. As the first eyelet 12 and second eyelet 14 do not traverse through a large area of the vision inhibitor 1, much of the user's peripheral vision is obstructed by either the first blinder 11 or the second blinder 13. Because the material used for the vision inhibitor 1 is opaque, the user's line of vision is restricted to the size of the cutouts. Effectively, the user's peripheral vision is eliminated or limited in some capacity. In turn, this allows the user to focus their vision on a single object or task.

In reference to FIG. 4 and FIG. 6, the first fastening region 16 and the second fastening region 17 are positioned at opposite ends of the vision inhibitor 1 and each provides a means of attachment between the strap 2 and the vision inhibitor 1. The first fastening region 16 being positioned on the first blinder 11 opposite the first eyelet 12 and the second fastening region 17 being positioned on the second blinder 13 opposite the second eyelet 14. The first fastening region 16 comprises a first extrusion 161 and a first strap 2 slot 162, while the second fastening region 17 comprises a second extrusion 171 and a second strap 2 slot 172. The first extrusion 161 is adjacently connected to the first blinder 11 and extends out to the side of the vision inhibitor 1. The first strap 2 slot 162 is a rectangular cut that traverses through the first extrusion 161 in order to create a closed loop portion of the vision inhibitor 1 along the first fastening region 16. Similarly, the second extrusion 171 is adjacently connected to the second blinder 13 and extends out to the side of the vision inhibitor 1 in a direction opposite that of the first extrusion 161. The second strap 2 slot 172 is a rectangular cut that traverses through the second extrusion 171 in order to create a closed loop portion of the vision inhibitor 1 along the second fastening region 17. Through these closed loop portions, the strap 2 is connected to the vision inhibitor 1.

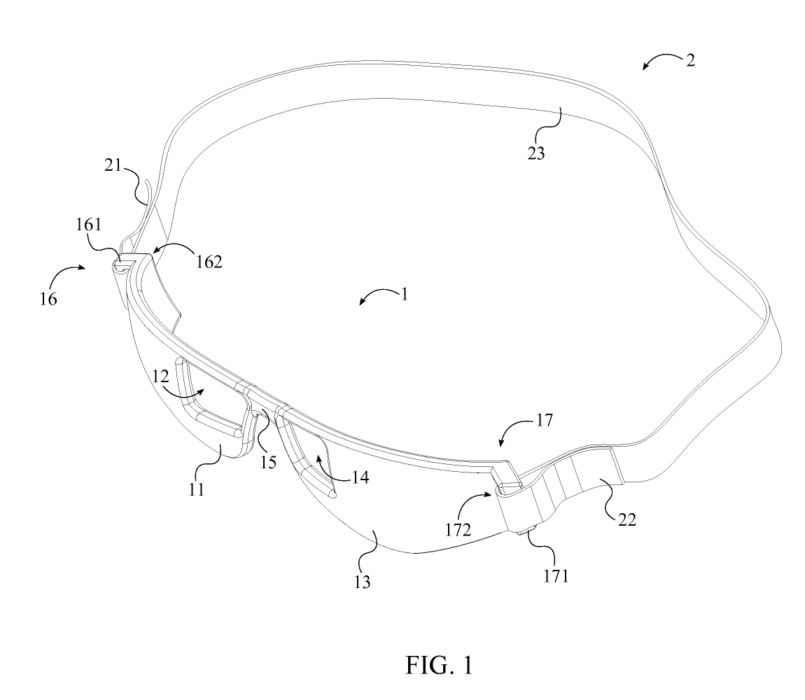

The strap 2 is connected to each end of the vision inhibitor 1 and is used to secure the vision inhibitor 1 to a user's head. It is possible for the strap 2 to be made of a number of different materials including, but not limited to, neoprene, nylon or an elastic material. An elastic material is ideal as it can be stretched to fit around various head sizes. The strap 2 allows the user to use the vision training tool while in motion, as it secures the vision inhibitor 1 to the user's head. Thus, athletes can carry out normal practice routines and drills with the additional use of the vision training tool. Athletes can then work to train their vision and muscle memory of their eyes in addition to the areas of the body normally focused on. In reference to FIG. 1, the strap 2 comprises a first strap end 21, a second strap end 22, and a strap midsection 23. The strap midsection 23 being positioned in between the first strap end 21 and the second strap end 22. The first strap end 21 and the second strap end 22 provide lengths of material that are used to connect the strap 2 to the vision inhibitor 1, with the first strap end 21 being connected to the first fastening region 16 and the second strap end 22 being connected to the second fastening region 17. The first strap end 21 is looped through the first strap 2 slot 162 in the first extrusion 161 and is connected to the strap midsection 23. Similarly, the second strap end 22 is looped through the second strap 2 slot 172 in the second extrusion 171 and is connected to the strap midsection 23. The first strap end 21 and the second strap end 22 are permanently affixed to the strap midsection 23, such that the strap midsection 23 provides a predetermined length of material that is used to secure the vision training tool around a user's head.

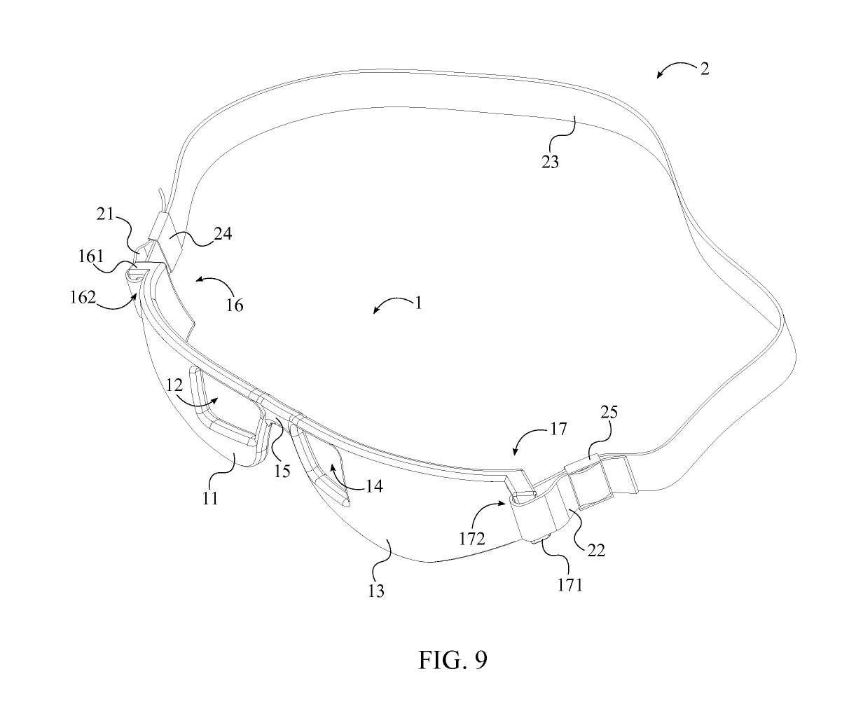

In other embodiments of the present invention, the strap 2 further comprises a first fastener 24 and a second fastener 25, as shown in FIG. 9. The first fastener 24 and the second fastener 25 allow the user to adjust the length of the strap midsection 23 in order to provide a more custom fit. The first fastener 24 is connected to the strap midsection 23 adjacent to the first strap end 21, while the second strap 2 fastener is connected to the strap midsection 23 adjacent to the second strap end 22. Once the first strap end 21 is looped through the first strap 2 slot 162, the first strap end 21 is then securely attached to the strap midsection 23 by the first fastener 24. Similarly, once the second strap end 22 is looped through the second strap 2 slot 172, the second strap end 22 is then securely attached to the strap midsection 23 by the second fastener 25. The first fastener 24 and the second fastener 25 can be any type of clamping device, locking mechanism, etc. that can securely hold the first strap end 21 and the second strap end 22, respectively, in place along the strap 2 mid-section. The first fastener 24 and the second fastener 25 provide a nonpermanent means of attachment, such that the length of the strap midsection 23 can be varied by either adjusting the first strap end 21 or the second strap end 22. In this way, the strap 2 is designed such that it is one size fits all no matter what type of material is used to construct the strap 2.

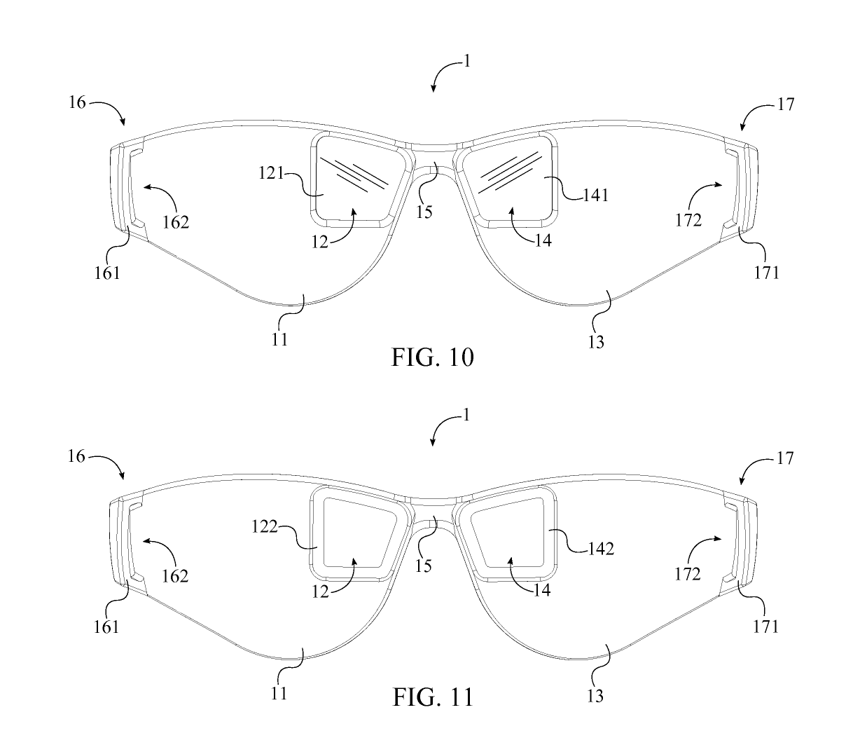

The vision training tool eliminates much of the user's peripheral vision, while still allowing the user to see through the first eyelet 12 and the second eyelet 14. Because the user's vision is limited they are forced to focus their vision on one specific object or task. Removing other visual distractions allows a user to focus on their training and help the user develop good muscle memory. The muscle memory that is developed in training will then be carried over to actual game time situations. The vision training tool is used to develop good game time habits that will translate into how an athlete performs when not using the vision training tool. In reference to FIG. 10, in an alternative embodiment of the present invention, the vision inhibitor 1 further comprises a first lens 121 and a second lens 141. The first lens 121 and the second lens 141 may be used for corrective purposes or to prevent anything from getting in the eyes of the user. It is also possible for the first lens 121 and the second lens 141 to be tinted in order to provide protection from the sun. The first lens 121 is positioned within the first eyelet 12 and is perimetrically attached to the first blinder 11.

Similarly, the second lens 141 is positioned within the second eyelet 14 and is perimetrically attached to the second blinder 13. The first lens 121 and the second lens 141 can be designed to be permanently attached to the vision inhibitor 1 or as removable inserts that can be attached to the vision inhibitor 1 as needed. In reference to FIG. 11, the vision inhibitor 1 further comprises a first eyelet insert 122 and a second eyelet insert 142 in another alternative embodiment of the present invention. The first eyelet insert 122 and the second eyelet insert 142 are used to decrease the size of the first eyelet 12 and the second eyelet 14, respectively, and thus further decrease the range of vision of the user. The first eyelet insert 122 and the second eyelet insert 142 can also be used to change the shape of the windows through which the user can see. The first eyelet insert 122 is positioned within the first eyelet 12 and is perimetrically attached to the first blinder 11. Similarly, the second eyelet insert 142 is positioned within the second eyelet 14 and is perimetrically attached to the second blinder 13. The first eyelet insert 122 and the second eyelet insert 142 may be removably attached to the vision inhibitor 1 in any way.

Although the invention has been explained in relation to its preferred embodiment, it is to be understood that many other possible modifications and variations can be made without departing from the spirit and scope of the invention as hereinafter claimed.

What is claimed is:

1. A vision training tool comprises:
a visual inhibitor;
a strap;
the visual inhibitor comprises a first blinder, a second blinder, a first eyelet, a second eyelet, a bridge, a first fastening region, and a second fastening region;
the strap comprises a first strap end, a second strap end, and a strap midsection;
the first blinder being adjacently connected to the bridge;
the second blinder being connected to the bridge opposite the first blinder;
the first eyelet traversing through the first blinder adjacent to the bridge;
the second eyelet traversing through the second blinder adjacent to the bridge;
the first fastening region being positioned on the first blinder opposite the first eyelet;
the second fastening region being positioned on the second blinder opposite the second eyelet;
the strap being connected to the visual inhibitor; and
the strap midsection being positioned in between the first strap end and the second strap end.

2. The vision training tool as claimed in claim 1 comprises:
the first strap end being connected to the first fastening region; and
the second strap end being connected to the second fastening region.

3. The vision inhibitor as claimed in claim 1 comprises:
the first fastening region comprises a first extrusion and a first strap slot;
the first extrusion being adjacently connected to the first blinder;
the first strap slot traversing through the first extrusion;
the first strap end looping through the first strap slot; and
the first strap end being connected to the strap midsection.

4. The vision inhibitor as claimed in claim 1 comprises:
the strap further comprises a first fastener;
the first fastening region comprises a first extrusion and a first strap slot;
the first extrusion being adjacently connected to the first blinder;
the first strap slot traversing through the first extrusion;
the first strap end looping through the first strap slot;
the first fastener being connected to the strap midsection adjacent to the first strap end; and
the first strap end being attached to the strap midsection by the first fastener.

5. The vision inhibitor as claimed in claim 1 comprises:
the second fastening region comprises a second extrusion and a second strap slot;
the second extrusion being adjacently connected to the second blinder;
the second strap slot traversing through the second extrusion;
the second strap end looping through the second strap slot; and
the second strap end being connected to the strap midsection.

6. The visual inhibitor as claimed in claim 1 comprises:
the strap further comprises a second fastener;
the second fastening region comprises a second extrusion and a second strap slot;
the second extrusion being adjacently connected to the second blinder;
the second strap slot traversing through the second extrusion;
the second strap end looping through the second strap slot;
the second fastener being connected to the strap midsection adjacent to the second strap end; and
the second strap end being attached to the strap midsection by the second fastener.

7. The vision training tool as claimed in claim 1 comprises:
the visual inhibitor further comprises a first lens and a second lens;
the first lens being positioned within the first eyelet;
the first lens being perimetrically attached to the first blinder;
the second lens being positioned within the second eyelet; and
the second lens being perimetrically attached to the second blinder.

8. The vision training tool as claimed in claim 1 comprises:
the visual inhibitor further comprises a first eyelet insert and a second eyelet insert;
the first eyelet insert being positioned within the first eyelet;
the first eyelet insert being perimetrically attached to the first blinder;
the second eyelet insert being positioned within the second eyelet; and
the second eyelet insert being perimetrically attached to the second blinder.

9. A vision training tool comprises:
a visual inhibitor;
a strap;
the visual inhibitor comprises a first blinder, a second blinder, a first eyelet, a second eyelet, a bridge, a first fastening region, and a second fastening region;
the strap comprises a first strap end, a second strap end, and a strap midsection;
the first fastening region comprises a first extrusion and a first strap slot;
the second fastening region comprises a second extrusion and a second strap slot;
the first blinder being adjacently connected to the bridge;
the second blinder being connected to the bridge opposite the first blinder;
the first eyelet traversing through the first blinder adjacent to the bridge;
the second eyelet traversing through the second blinder adjacent to the bridge;
the first fastening region being positioned on the first blinder opposite the first eyelet;
the first extrusion being adjacently connected to the first blinder;
the first strap slot traversing through the first extrusion;
the second fastening region being positioned on the second blinder opposite the second eyelet;
the second extrusion being adjacently connected to the second blinder;
the second strap slot traversing through the second extrusion;
the strap being connected to the visual inhibitor;
the first strap end looping through the first strap slot;
the second strap end looping through the second strap slot; and
the strap midsection being positioned in between the first strap end and the second strap end.

10. The vision inhibitor as claimed in claim 9 comprises:
the first strap end being connected to the strap midsection; and
the second strap end being connected to the strap midsection.

11. The vision inhibitor as claimed in claim 9 comprises:
the strap further comprises a first fastener;
the first fastener being connected to the strap midsection adjacent to the first strap end; and
the first strap end being attached to the strap midsection by the first fastener.

12. The visual inhibitor as claimed in claim 9 comprises:
the strap further comprises a second fastener;
the second fastener being connected to the strap midsection adjacent to the second strap end; and
the second strap end being attached to the strap midsection by the second fastener.

13. The vision training tool as claimed in claim 9 comprises:
the visual inhibitor further comprises a first lens and a second lens;
the first lens being positioned within the first eyelet;
the first lens being perimetrically attached to the first blinder;
the second lens being positioned within the second eyelet; and
the second lens being perimetrically attached to the second blinder.

14. The vision training tool as claimed in claim 9 comprises:
the visual inhibitor further comprises a first eyelet insert and a second eyelet insert;
the first eyelet insert being positioned within the first eyelet;
the first eyelet insert being perimetrically attached to the first blinder;
the second eyelet insert being positioned within the second eyelet; and
the second eyelet insert being perimetrically attached to the second blinder.

15. A vision training tool comprises:
a visual inhibitor;
a strap;
the visual inhibitor comprises a first blinder, a second blinder, a first eyelet, a second eyelet, a bridge, a first fastening region, and a second fastening region;
the strap comprises a first strap end, a second strap end, a strap midsection, a first fastener, and a second fastener;
the first fastening region comprises a first extrusion and a first strap slot;
the second fastening region comprises a second extrusion and a second strap slot;
the first blinder being adjacently connected to the bridge;
the second blinder being connected to the bridge opposite the first blinder;
the first eyelet traversing through the first blinder adjacent to the bridge;
the second eyelet traversing through the second blinder adjacent to the bridge;
the first fastening region being positioned on the first blinder opposite the first eyelet;
the first extrusion being adjacently connected to the first blinder;
the first strap slot traversing through the first extrusion;
the second fastening region being positioned on the second blinder opposite the second eyelet;
the second extrusion being adjacently connected to the second blinder;
the second strap slot traversing through the second extrusion;
the strap being connected to the visual inhibitor;
the first strap end looping through the first strap slot;
the second strap end looping through the second strap slot; and
the strap midsection being positioned in between the first strap end and the second strap end.

16. The vision inhibitor as claimed in claim 15 comprises:
the first fastener being connected to the strap midsection adjacent to the first strap end; and
the first strap end being attached to the strap midsection by the first fastener.

17. The visual inhibitor as claimed in claim 15 comprises:
the second fastener being connected to the strap midsection adjacent to the second strap end; and
the second strap end being attached to the strap midsection by the second fastener.

18. The vision training tool as claimed in claim 15 comprises:
the visual inhibitor further comprises a first lens and a second lens;
the first lens being positioned within the first eyelet;
the first lens being perimetrically attached to the first blinder;
the second lens being positioned within the second eyelet; and
the second lens being perimetrically attached to the second blinder.

19. The vision training tool as claimed in claim 15 comprises:
the visual inhibitor further comprises a first eyelet insert and a second eyelet insert;
the first eyelet insert being positioned within the first eyelet;
the first eyelet insert being perimetrically attached to the first blinder;
the second eyelet insert being positioned within the second eyelet; and
the second eyelet insert being perimetrically attached to the second blinder.
